(19) United States
(12) Patent Application Publication
(10) Pub. No.: US 2006/0168815 A1
(43) Pub. Date: Aug. 3, 2006

(54) Method for producing a metallic dental implant and a blank for carrying out said method

(76) Inventors: Gunter Saliger, Bensheim (DE); Joachim Pfeiffer, Bensheim (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/548,076

(22) PCT Filed: Mar. 5, 2004
(86) PCT No.: PCT/DE04/00449

§ 371 Date: Sep. 6, 2005

(30) Foreign Application Priority Data
Mar. 5, 2003 (DE) 103 09 795.3

(51) Int. Cl. A61C 5/10; B21F 43/00

(52) U.S. Cl. 29/896.11; 29/896.1

(57) ABSTRACT

The invention relates to a method for producing a metallic dental implant, to a blank, an intermediate body and a binder for producing said implant. The inventive method consists in obtaining a blank consisting of a solid powder metaliferous mixture, in processing said blank in such a way that the intermediate body is produced, and in treating said intermediate body in order to obtain desired properties of the dental implant material.

### TECHNICAL FIELD

The invention relates to a process for the production of a dental prosthetic item from metallic materials, and to a blank and a green compact and a binder for the production of said dental prosthetic item of metal.

The advantages of metallic frameworks for dental prosthetic items are, in comparison with ceramics, their higher ductility and their lower susceptibility to tensile stress. This fact is additionally utilized to realize a more filigreed design of the dental prosthetic items in conjunction with reduced wall thicknesses. Moreover, simpler forms and types requiring less technical skill can be allowed for the preparation. In addition, dental prosthetic items of this type can be fixed using cement in the tooth. From the dentist's point of view, handling thereof appears simpler and more robust compared with the adhesive technique.

### DESCRIPTION OF THE RELATED ART

In dentistry, a multiplicity of metallic alloys are used for the production of crowns and bridges. With the aid of casting processes, caps and frameworks or complete restorations are produced from these metals by the lost mold process. These are then either used directly or possibly after veneering with ceramics or plastics materials.

In addition to this traditional process, it is known that such alloys can also be processed using CAD/CAM machines. The technical properties of these alloys, however, make considerable demands on such machining equipment with respect to their rigidity, their drives, and their tools. On the whole, these demands result in a machine which comes close in size and price to the customary CNC machine and can only be afforded by a few dental laboratories and dentists. EP 0 214 341 discloses a process for the production of a metallic prosthetic item in which a mixture of metal powders is prepared with a mixing fluid to give a spreadable mass and is sintered. The metal powder mixture is in this case modeled on a model serving as a firing support and is sintered on the model. Essentially the same technique is described in EP 0 373 380 A2.

In the field of dental ceramics, it is known from DE 199 30 564 Al to form a ceramic blank from a powdered ceramic raw material, to impart an internal contour and/or external contour to this ceramic blank by processing by means of carving techniques, and to sinter the processed ceramic green blank to give a high-strength shaped ceramic body. The ceramic material is chosen so as to allow a pressing aid to be used which, on sintering, approximately compensates for the shrinkage to be expected due to sintering.

DE 199 38 144 Al discloses a process for the production of a prosthetic item from a presintered blank in machining equipment, in which the blank has a green strength of 15 to 30 MPa. This blank is processed by milling, grinding, or by erosion. The green compact can in this case be remodeled by means of suitable operations to form an oversize model of the final dental prosthetic item adjusted to compensate for the shrinkage. This can be carried out, in particular, by the use of a CAD/CAM process. Subsequently, it is brought to its final dimensions by sintering.

Another route is demonstrated in DE 199 01 643 A1, in which a molded article is built up layerwise with a sinterable powder by exposing each layer of the powder to an energy of a laser beam which leads to local sintering.

EP 0 630 622 A2 reveals the fundamental problem involved in processing high-strength ceramic or metallic dental prosthetic items and discloses, in particular, a ceramic dental prosthetic item.

Generally, ceramic sintered materials have the disadvantage that with a shrinkage of 25% a comparatively large volume has to be machined by the machining equipment.

It is an object of the invention to provide a dental prosthetic item made of metallic materials und to provide a process which alters the material properties of the material in such a way that it is processable in a machine designed for machining dental ceramics.

### SUMMARY AND OBJECTS OF THE INVENTION

The invention is based on the discovery that grinding of a primary stage and subsequent after-treatment thereof, e.g. by means of sintering with shrinkage, can also give the results desired for a metallic dental prosthetic item.

According to the invention, the process for the production of dental prosthetic items from metallic materials consists in providing a blank shaped and compacted from a metal-containing powder mixture, processing the blank to give an intermediate article, and effecting aftertreatment of the intermediate article in a third step, by which means the desired material properties of the dental prosthetic item are achieved.

The invention is based on the fact that processing is carried out not on the metallic material having the final material properties, but rather on a primary stage thereof. This primary stage of the material obtains its strength by means of binders, which are subsequently removed, and/or by means of pressure or temperature compaction such that an adequately solid blank is obtained. The properties of the primary stage are adjusted such that shape-accurate carving and good handling of the materials, designated here as blanks, are afforded.

The procedure according to the invention breaks with the customary concept of producing dental prosthetic items from metallic materials, according to which a complex individual shape of metal is produced either by casting or by machining in an NC machine.

Advantageously, before the blank is processed, the dental prosthetic item designed to final size is adjusted in its dimensions to allow for further expected modifications in shape of the metallic material and, accordingly, an intermediate article is designed. The alterations in shape resulting from aftertreatment of the machined blank are subject to physical conditions, which can be described by modeling or result from aspects of the technique used for said aftertreatment. With the aid of a calculator program, it is possible, taking into consideration the distortions to be expected during subsequent processing, to make an inverse representation und thus to produce an intermediate article which, following aftertreatment, gives the desired shape of the dental prosthetic item with great precision.

According to one refinement, the aftertreatment can comprise pressure and/or heat treatment. Sintering at high temperatures is particularly suitable.

Advantageously, as part of the aftertreatment, a binder present in the metal-containing powder mixture of the blank is at least partially removed.

The metal-containing powder mixture can be a single mode or multimode mixture of metal powders, optionally with the addition of a binder. Suitable materials here are in particular alloys or metals such as are known in the prior art to be suitable for dental applications, such as AuPt, AuPdAg, PdAg, AuPd, NiCr, CoCr, Pd, and Ti.

Advantageously, machining of the blank for the production of the intermediate article is carried out by grinding and/or milling in a grinding or milling machine suitable for machining dental ceramics.

The invention further relates to a blank for the production of dental prosthetic items from metallic materials. The blank consists of a metal-containing powder mixture. The metal-containing powder mixture comprises metal powder of one or more particle sizes and/or shapes, the blank preferably having a strength of more than 40 MPa (40·10⁶ N/m²).

Its strength is advantageously distinctly less than the final strength of the finished dental prosthetic item.

This ensures that, on the one hand, the blank has adequate intrinsic strength to withstand the machining forces and that, on the other hand, problem-free machining of the blank is possible in a customary dental milling or grinding machine.

Advantageously, the metal-containing powder mixture in the blank is compacted such that the blank has adequate strength to withstand the forces occurring during machining.

The powder mixture forming the blank can consist of a mixture in which various metals are present and the composition of the mixture in the blank can be dependent on its position therein.

In particular, the marginal regions of the blank can be formed such that a lower final strength is achieved than in the central regions of the blank. This can be advantageous if various objectives have to be fulfilled at one and the same time, such as to achieve resistance to the masticatory pressure and to attain a favorable abrasion behavior and strength, and to produce tight interlocking with the dentine.

According to one development, the blank consists of a metal-containing powder mixture and a binder, the amount of the latter being such that the binder-containing powder mixture is moldable. The binder can be present in the form of powder.

Advantageously, the amount of binder present in the blank is greater than 20% by volume and is at most 50% by volume.

In another development, the blank is formed from a compacted metal-containing powder mixture and the binder is present in an amount of less than 20% by volume, preferably less than 0.5% by volume. The amount of binder can have been reduced by partial dissolution of an originally higher amount. It may also be possible, by means of compaction, to dispense with an additional binder altogether.

The blank can contain surface elements by means of which mating with other bodies is possible. When producing an intermediate article, it is not necessary to machine these surface elements.

The invention further relates to an intermediate article for the production of a dental prosthetic item which is fabricated by machining a blank as described above. The intermediate article differs from the dental prosthetic item to be produced by the amount of the dimensional change to be expected during the final thermal treatment and advantageously has a strength (0.2% yield strength) of more than 40 MPa (40·10⁶ N/m²). Advantageously, the strength is here again distinctly lower than the final strength of the finished dental prosthetic item.

Yet a further object of the invention is to provide a dental prosthetic item made of metal, which contains sintered metal particles and whose strength (0.2% yield strength) is greater than 100 MPa (100·10⁶ N/m²).

The dental prosthetic item advantageously has a residual content of binder of less than 0.1% and is preferably completely devoid of binder.

Both the blank and the dental prosthetic item or the intermediate part can contain as binder a material which volatilizes on heating at temperatures above 100° C.

Yet another object of the invention is to provide a binder for a blank, a dental prosthetic item, or an intermediate part, made of metal, which contains, to an extent of at least 90%, organic materials, for example wax or synthetic resin, having a volatilization point of above 100° C. and below 600° C.

Yet a further object of the invention is to provide a process for the production of a blank containing metallic materials. In this process, a metal-containing powder mixture is molded to produce a blank, which is then compacted.

Furthermore, the powder mixture of metal and binder can be compressed by means of pressure and/or heat treatment.

A binder can be added to the metal-containing powder mixture before the blank is produced, in order to make it possible to shape the blank by means of injection molding or extrusion.

Advantageously, the binder is removed before the blank is machined. In this case, compaction of the blanks can be carried out by means of pressure and/or temperature after or even during removal of the binder.

Advantageously, the content of the binder in the total mixture is between 20 and 50 percent by volume (vol %).

Preferably, the position-dependent composition of the mixture for the production of a blank is produced from a gradient material by laminate molding, sedimenting or spraying. However, the position-dependent composition of the mixture in the blank can alternatively be obtained only by means of further process steps, such as, for example, chemical bonding or diffusion of additives.

Yet another object of the invention is to provide a metal-containing powder mixture for the production of a blank for fabrication of dental prosthetic items. The powder mixture has a content of metallic materials of at least 50% by volume.

### BRIEF DESCRIPTION OF THE DRAWINGS

Exemplary embodiments of the invention are shown in the figures, in which:

FIG. 1 is a flow sheet of the process according to the invention,

FIG. 2 shows a blank,

FIG. 3 shows an intermediate article and

FIG. 4 shows a dental prosthetic item.

### DETAILED DESCRIPTION OF EXEMPLARY EMBODIMENTS OF THE INVENTION

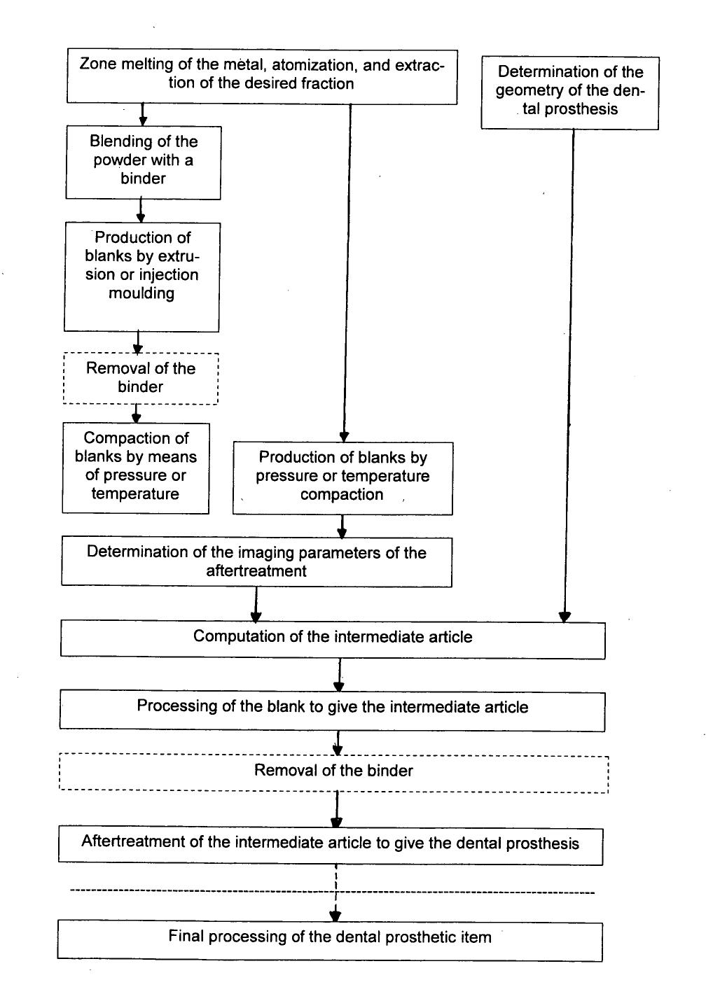

FIG. 1 shows a flow sheet to illustrate the process according to the invention. For the production of the dental prosthetic item, a blank is used which consists of metal powders of single-mode or multimode particle sizes and/or shapes. These powders are produced, for example, by atomization or chemical deposition. By single mode particle sizes are meant particles of one size distribution, whilst multimode particles comprise particles of different size distributions.

The blank can be produced from these powders by pressure or temperature compaction. If binders are added to the powders, they can be converted to blanks by injection molding, extrusion, or other shaping processes. Subsequently, the binders can be removed and, optionally, further compaction of the blanks can be carried out by means of pressure or temperature.

The consistency of these blanks is adjusted so that they are sufficiently solid to be machined by grinding or milling tools. In this case, in particular, machining with a conventional grinding or milling machine for dental ceramics should be possible without making alterations to the machine.

An important limiting condition is that it is necessary for the modification in shape which the material undergoes during the final thermal treatment (aftertreatment) to be exactly predictable with reference to a model. Following the design of the workpiece, this model is applied to the object to be fitted in order to alter the shape and size in such a way that the body, after final processing, will have exactly the shape which is actually required for the current application. The characteristics for each material can be found by means of experiments which relate to the process parameters of the final thermal treatment (aftertreatment). It is usually found that the characteristics are batch-dependent.

The production of a dental prosthetic item is based on the situation present in the patient. The topographic condition of the area to be treated is scanned after preparation has been carried out. This can be done, for example, directly in the mouth of the patient by means of a scanning camera or it can be carried out indirectly with the aid of a positive or negative cast of said region.

The workpieces are then modeled in known manner. This is usually effected by means of computer-aided processes. After designing the dental prosthetic item in its final specific size, it is adjusted with the aid of imaging rules such that any distortions that will arise from subsequent processing are neutralized. This gives an intermediate article which will be produced by machining the blank.

When the intermediate article has been fabricated, any binder still present is expelled and the intermediate part is imparted with the technically desired final properties of the dental prosthetic item by an aftertreatment (e.g. by sintering). This usually causes a change of shape. However, the manner of the change in shape has already been allowed for with the aid of the model, so that the final shape of the dental prosthetic item is precisely as desired.

Further improvement of the workpiece, e.g. by means of veneering with ceramic or plastic compositions and/or by polishing etc., can follow.

As a result of the invention, the broad field of metal restoration is laid open for grinding machines for dental ceramics.

In FIGS. 2 to 4, a blank, an intermediate article, and a dental prosthetic item are shown.

Blank 1 shown in FIG. 2 is fixed to a handle 2, which is used for mounting the blank in the chuck of a grinding or milling machine suitable for machining dental ceramics. The external dimensions of blank 1 are such that an intermediate part 3 to be produced from the blank lies completely within the blank. The blank has sufficient strength to ensure that machining a region of the blank will not cause destruction of the whole structure of the blank.

Blank 1 contains a preformed surface element 4, which can create a mating fit to other bodies. It is not necessary to machine this surface element 4, since it already possesses the final geometry. Moreover, in intermediate article 3, a mating surface 5 is indicated which must be produced entirely by carving.

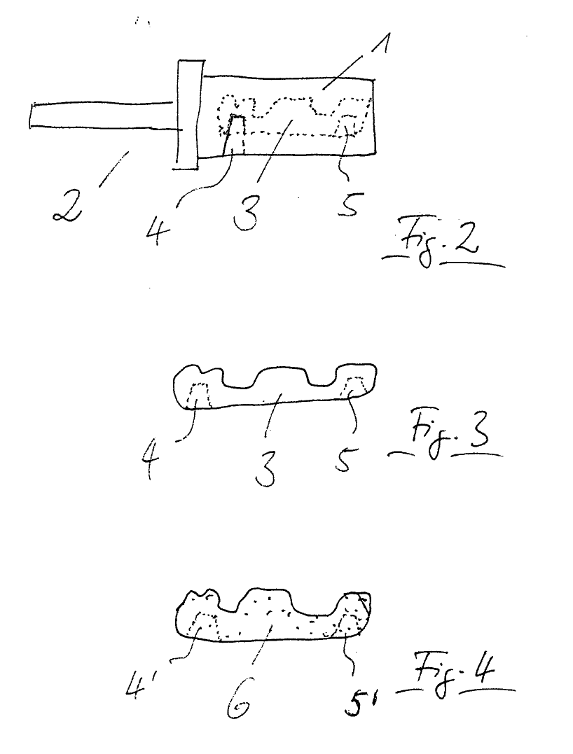

In FIG. 3, the intermediate part carved out of blank 1 of FIG. 2 is shown. Surface element 4 and recess 5 are shown. Intermediate body 3 is oversized relative to its final dimensions to an extent corresponding to the shrinkage parameters of the expected dimensional modification due to the aftertreatment. This also applies to the prefinished surface element 4.

In FIG. 4, a dental prosthetic item 6 resulting from intermediate article 3 of FIG. 3 by aftertreatment is shown with its final material properties. Dental prosthetic item 6 also has the final geometrical dimensions which have resulted, for example, from shrinkage of the intermediate article during thermal aftertreatment.

1-28. (canceled)

29. A process for the production of a dental prosthetic item (6) from metallic materials, wherein
a blank (1) is prepared by molding a metal-containing powder mixture and solidifying the same, the consistency of said blank (1) being adjusted such that it is sufficiently solid to permit machining thereof with machining tools by milling or grinding, and
in a second step, an intermediate article (3) is produced from said blank (1), machining of said blank (1) to produce said intermediate article being effected by grinding or milling in a grinding or milling machine suitable for machining dental ceramics, and
in a third step, said intermediate article (3) is subjected to aftertreatment, by means of which the desired material characteristics of the dental prosthetic item (6) are achieved, which aftertreatment comprises a pressure and/or thermal treatment, and prior to machining said blank (1), the dental prosthetic item (6) designed with its final dimensions is dimensionally modified to allow for expected deformation of said metallic material, so that said intermediate article is designed.

30. A process as defined in claim 29, wherein said aftertreatment comprises final thermal processing of the machined blank (1), during which metal particles of the metallic material are sintered.

31. A process as defined in claim 29, wherein, as part of the aftertreatment, at least a portion of any binder present in the metal-containing powder mixture of said blank (1) is removed.

32. A blank (1) for the production of dental prosthetic items of metallic materials, wherein said blank (1) consists of a metal-containing mixture of powders containing a binder, the proportion of which is such that the mixture of powders including binder is moldable and that the metal-containing mixture of powders comprises metal powder of one or more particle sizes and/or shapes and said blank (1) is compacted, and the binder is present in a concentration of less than 20% by volume.

33. A blank as defined in claim 32, wherein the mixture of powders consists of a solids mixture in which various metals are present.

34. A blank as defined in claim 33, wherein the composition of the batch is position-dependent.

35. A blank as defined in claim 32, wherein said blank has a strength of more than 40 MPa (40·10⁶ N/m²).

36. A blank as defined in claim 32, wherein said blank (1) contains surface elements (4) which can provide mating surfaces for other bodies.
